(19) United States
(12) Patent Application Publication
(10) Pub. No.: US 2013/0016046 A1
(43) Pub. Date: Jan. 17, 2013

(54) CONTROL METHOD AND SYSTEM OF TOUCH PANEL

(71) Applicants: Li-Chung Chou, Taipei City (TW); Yung-Hsiang Chen, Taipei City (TW); Cheng-Hao Li, Taipei City (TW); Leonard Tsai, Taipei City (TW)

(72) Inventors: Li-Chung Chou, Taipei City (TW); Yung-Hsiang Chen, Taipei City (TW); Cheng-Hao Li, Taipei City (TW); Leonard Tsai, Taipei City (TW)

(73) Assignee: COMPAL ELECTRONICS, INC., Taipei City (TW)

(21) Appl. No.: 13/239,350

(22) Filed: Sep. 21, 2011

(30) Foreign Application Priority Data
Jul. 13, 2011 (TW) 100124761

(51) Int. Cl. G06F 3/041

(52) U.S. Cl. 345/173

(57) ABSTRACT

A control method and system of a touch panel are provided. In the present method, at least one active area on the touch panel is selected first, and the remaining area of the touch panel is defined as an inactive area of the touch panel. Then, the inactive area is disabled. Thereafter, a corresponding action is executed on an electronic device according to a touch operation performed on the at least one active area. As a result, the power consumption can be reduced by disabling the inactive area while the electronic device is controlled by the at least one active area of the touch panel.

### CROSS-REFERENCE TO RELATED APPLICATION

This application claims the priority benefit of Taiwan application serial no. 100124761, filed on Jul. 13, 2011. The entirety of the above-mentioned patent application is hereby incorporated by reference herein and made a part of this specification.

### BACKGROUND OF THE INVENTION

1. Field of the Invention

The invention relates generally to a touch panel, and is particularly to a control system and a control method of an electronic device by a touch panel.

2. Description of Related Art

With the advancement of touch sensing technologies, more and more electronic devices are beginning to adopt the touch screen for device output and for use as the input unit. Taking mobile electronic devices such as the mobile phone or the tablet computer by way of example, using a touch screen not only saves the space of the actual keyboard and allows the device to appear more light weight, thin and compact, but the display screen can be further increased so a user can feel more convenience during operation.

Generally speaking, the touch screen includes a display panel for the display function, and a touch panel for sensing a touch operation from the user. However, recent conventional touch screens only support full screen usage. In other words, the user can only choose to completely turn on or turn off the touch screen. While the touch screen is being completely turned on, since all the regions of the touch panel are supplied power to sense the user operation, a large amount of power is consumed.

From another perspective, when the user has set up input devices such as a keyboard or a mouse on the electronic device configured with the touch screen, even though the user does not use the touch screen for input, the overall amount of power consumption for the electronic device is adversely affected because the power of the touch screen has not been turned off.

### SUMMARY OF THE INVENTION

Accordingly, the invention provides a control method of a touch panel, capable of using any arbitrary partial area of the touch panel to control the electronic device.

The invention provides a control system of a touch panel, capable of disabling a particular portion of the touch panel, and only operating the electronic device through the area not disabled.

The invention provides a control method of a touch panel, the method including selecting at least one active area on the touch panel, and defining the remaining area as an inactive area of the touch panel. Next, the inactive area is disabled. Thereafter, an action is executed on an electronic device according to a first touch operation performed on the at least one active area.

According to an embodiment of the invention, the step of selecting the at least one active area on the touch panel includes dividing the touch panel into a plurality of predetermined areas, and determining the at least one active area according to at least one second touch operation performed on at least one of the predetermined areas.

According to an embodiment of the invention, the step of selecting the at least one active area on the touch panel includes determining the at least one active area according to at least one closed area generated by at least a third touch operation performed continuously on the touch panel.

According to an embodiment of the invention, the step of disabling the inactive area includes turning off a power provided to the inactive area.

According to an embodiment of the invention, the touch panel includes a plurality of touch sensors, and the step of turning off the power provided to the inactive area includes turning off the power provided to the touch sensors disposed in the inactive area.

According to an embodiment of the invention, the step of disabling the inactive area includes turning off at least one of a touch function and a signal transmission function of the inactive area.

According to an embodiment of the invention, the step of disabling the inactive area includes not processing a touch signal detected by the inactive area.

According to an embodiment of the invention, the touch panel corresponds to a display area of a display, and after the step of selecting the at least one active area on the touch panel, the method further includes executing a positioning calibration program to redefine a position correlation of the at least one active area and the display area.

According to an embodiment of the invention, the action executed on the electronic device includes at least a pointer movement action, an object selection action, an object drag action, an object open action, and a character input action, etc.

From another perspective, the invention provides a control system of a touch panel, the control system including a touch panel, a control chip, and a managing module. The control chip is coupled to the touch panel, and the managing module is coupled to the control chip. The managing module selects at least one active area on the touch panel, and defines the remaining area as an inactive area of the touch panel. The managing module notifies the control chip to disable the inactive area, and the managing module executes an action on an electronic device according to a first touch operation performed on the at least one active area.

According to an embodiment of the invention, the managing module divides the touch panel into a plurality of predetermined areas. When the touch panel detects at least one second touch operation performed on at least one of the predetermined areas, the control chip transmits at least one area selection command corresponding to the at least one second touch operation to the managing module, and the managing module determines the at least one active area corresponding to the at least one second touch operation.

According to an embodiment of the invention, when the touch panel detects at least one third touch operation performed continuously on the touch panel, the control chip transmits at least one area selection command corresponding to the at least one third touch operation to the managing module, and the managing module determines the at least one active area corresponding to at least one closed area generated by the at least one third touch operation.

According to an embodiment of the invention, the control chip turns off a power provided to the inactive area to disable the inactive area.

According to an embodiment of the invention, the touch panel includes a plurality of touch sensors, and when the control chip turns off the power provided to the inactive area, the control chip turns off the power provided to the touch sensors disposed in the inactive area.

According to an embodiment of the invention, the control chip turns off at least one of a touch function and a signal transmission function of the inactive area to disable the inactive area.

According to an embodiment of the invention, the control chip notifies the managing module to not process a touch signal detected by the inactive area to disable the inactive area.

According to an embodiment of the invention, the touch panel corresponds to a display area of a display, and after the managing module selects the at least one active area, a positioning calibration program is executed to redefine a position correlation of the at least one active area and the display area.

According to an embodiment of the invention, the action executed on the electronic device includes at least a pointer movement action, an object selection action, an object drag action, an object open action, and a character input action.

In summary, in embodiments of the invention, after selecting the active area on the touch panel, the area not belonging to the active area is disabled, and only the active area being provided power is used to control the electronic device. Accordingly, while partially using the touch panel to control the electronic device, other areas of the touch panel are turned off to achieve a power saving effect.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a control system of a touch panel according to an embodiment of the invention.

FIG. 2 is a flowchart of a control method of a touch panel according to an embodiment of the invention.

FIG. 3 is a schematic view illustrating a touch panel and an active area according to an embodiment of the invention.

FIG. 4A is a schematic view illustrating a touch panel and an active area according to another embodiment of the invention.

FIG. 4B is a schematic view illustrating a touch panel and an active area according to another embodiment of the invention.

FIG. 5 is a schematic view illustrating a touch panel and an active area according to another embodiment of the invention.

FIG. 6 is a schematic view illustrating a touch panel according to an embodiment of the invention.

FIG. 7 is a schematic view illustrating a correlation between a touch panel and a display area according to an embodiment of the invention.

### DESCRIPTION OF EMBODIMENTS

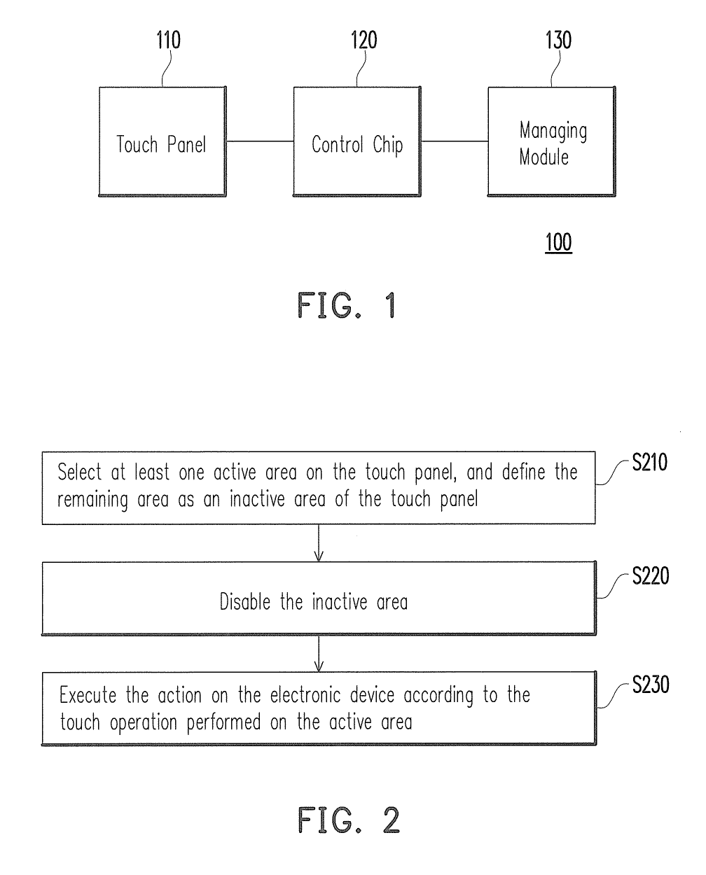

FIG. 1 is a block diagram illustrating a control system of a touch panel according to an embodiment of the invention. Referring to FIG. 1, a control system of the touch panel includes a touch panel 110, a control chip 120, and a managing module 130. The control system 100 is adapted to allow a user to operate an electronic device through a partial region of the touch panel 110. Moreover, in the present embodiment, the control system 100 disables inactive areas on the touch panel 110, and thereby the control system 100 achieves savings in power consumption. The electronic device may be exemplarily a notebook computer, a tablet computer, a handheld game console, a mobile phone, a smartphone, a personal digital assistant (PDA), or an electronic book, and the invention does not limit the type of the electronic device.

The touch panel 110 detects different types of touch operations the user performs thereon, and generates the corresponding touch signals. For example, a touch operation may be a single tap or a double tap on the touch panel 110 performed by fingers or an input apparatus; a sliding movement on the touch panel 110 performed by fingers or the input apparatus; a drag, a long-hold, or a pinch movement on the touch panel 110 performed by fingers or the input apparatus. In the present embodiment, the touch panel 110 is, for example, a resistive touch panel, a capacitive touch panel, an optical touch panel, or an acoustic-wave touch panel, and may be other types of touch devices, since the invention places no restrictions on the touch panel type.

The control chip 120 is coupled to the touch panel 110 and the managing module 130. The control chip 120 controls the overall operation of the touch panel 110. For example, the control chip 120 can control the on and off states of a power or a power source of the touch panel 110. Moreover, when the touch panel 110 detects the touch operation from the user and emits the corresponding touch signal, the control chip 120 generates a corresponding command and transmits the command to the managing module 130. Furthermore, the control chip 120 may receive a command from the managing module 130, and according to this command the control chip 120 can control the on and off states of the power or the power source of the touch panel 110.

In the present embodiment, the managing module 130 may be configured in a driver program or an application program of the electronic device. In other embodiments of the invention, the managing module 130 may also be implemented by a hardware component or a combination of hardware components and software components. Through the command transmitted from the control chip 120, the managing module 130 can determine the type of touch operation performed on the touch panel 110 by the user, and accordingly a corresponding operation can be executed on the electronic device.

In the present embodiment, the control system 100 of the touch panel only uses a partial area of the touch panel 110 to serve as a control region of the electronic device. In order to further illustrate the operation of the control system 100 of the touch panel, another embodiment is enumerated for more detailed description below. FIG. 2 is a flowchart of a control method of a touch panel according to an embodiment of the invention. Please refer to FIGS. 1 and 2 concurrently for the description below.

In a Step S210, the managing module 130 selects at least one active area on the touch panel 110, and the managing module 130 defines a remaining area excluding the at least one active area as an inactive area of the touch panel 110. Specifically, the managing module 130 may define any one arbitrary area on the touch panel 110 as the active area, or the managing module 130 may define a plurality of arbitrary areas on the touch panel 110 as the active area. Different embodiments are enumerated below to illustrate how the managing module 130 determines the active area.

Using FIG. 3 as an example, in the present embodiment the managing module divides the touch panel 110 into nine predetermined areas beforehand (e.g., predetermined areas P1 to P9). When the touch panel 110 detects a touch operation performed on one of the nine predetermined areas (e.g., the predetermined area has been double tapped by fingers or an input apparatus, or with other kinds of touch operations), this represents the user has selected the predetermined area. At this time, the control chip 120 transmits an area selection command corresponding to the touch operation to the managing module 130. The area selection command may include a location information of the user selected predetermined area. Therefore, the active area determined by the managing module 130 according to the area selection command corresponds to the touch operation performed by the user. For example, when the touch panel 110 detects the user has double tapped an arbitrary position in the predetermined area P9 with fingers, after the managing module 130 receives the corresponding area selection command through the control chip 120, the managing module 130 defines the predetermined area P9 as the active area of the touch panel 110, and thereafter defines the predetermined areas P1 to P8 as the inactive area. In another embodiment, the user may also select two or more predetermined areas on the touch panel 110 as the active area. For example, the user may double tap with fingers any arbitrary position in the predetermined areas P7 and P9 concurrently (or one after the other). After the managing module 130 receives the corresponding area selection command, the predetermined areas P7 and P9 are defined as the active area, and the predetermined areas P1 to P6 and P8 are defined as the inactive area. It should be noted that, in the above-described embodiments, the division and the quantity of the predetermined areas, as well as the type of touch operation during the area selection are simply an exemplary description for convenience, and it does not limit the scope of the invention.

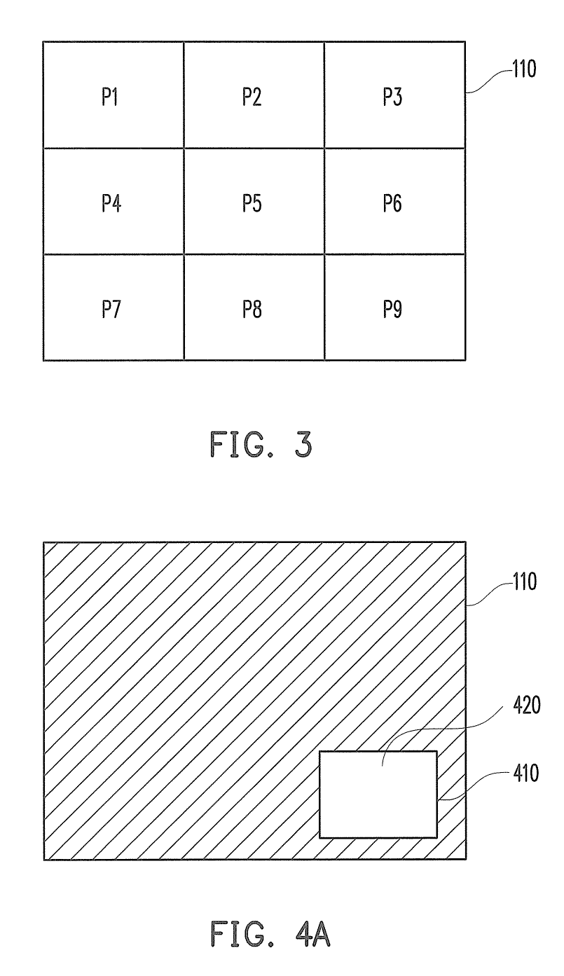

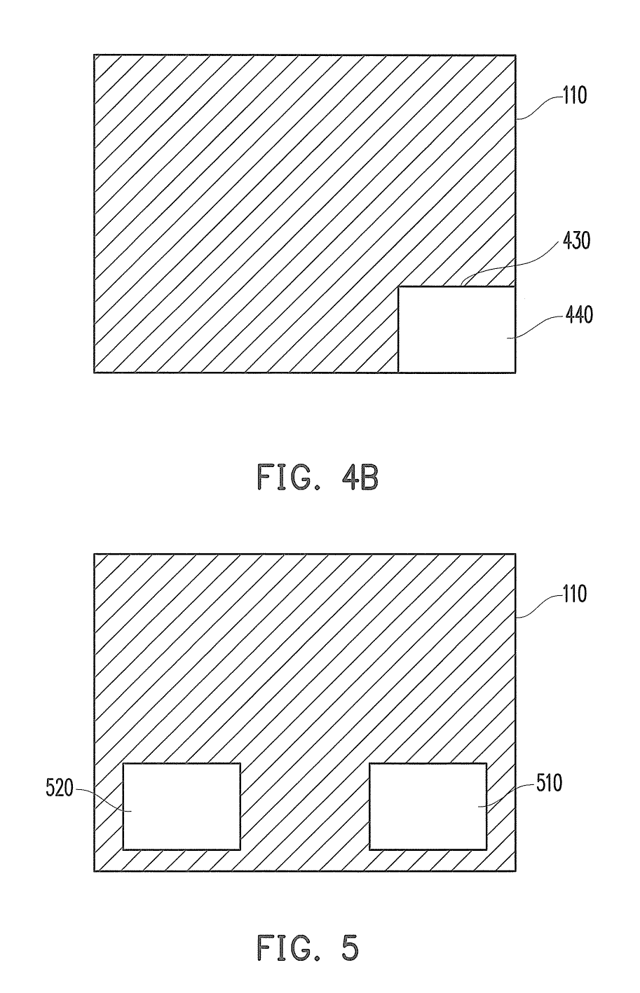

In another embodiment of the invention, the user can draw any arbitrary active area needed on the touch panel 110. Specifically, when the touch panel 110 detects a sustained contact from the user's fingers or from the input apparatus on the touch panel 110 and a slide operation is performed, the control chip 120 determines that the touch operation from the user at this time is to user-configure the active area, and therefore the corresponding area selection command is transmitted to the managing module 130. The area selection command may include the location information of a track formed by the touch operation of the user, or any information allowing the managing module 130 to determine the active area. Accordingly, the active area determined by the managing module 130 according to the area selection command corresponds to a closed area generated by the touch operation. For example, as shown in FIG. 4A, assume that the user has drawn a rectangular track 410 at a bottom right corner of the touch panel 110 with fingers. The managing module 130 defines a closed area 420 formed by the rectangular track 410 as the active area, and the managing module 130 defines a remaining area on the touch panel 110 excluding the rectangular track 410 (i.e., the area represented by slanted lines) as the inactive area. As shown in FIG. 4B, the managing module 130 may also define a closed area 440 formed by a user drawn track 430 and the edges of the touch panel 110 (e.g., the right edge and the bottom edge in the present embodiment) as the active area. On the other hand, as shown in FIG. 5, when the user has drawn two closed areas 510 and 520 on the touch panel 110, the managing module 130 respectively defines each of the closed areas 510 and 520 as an active area. Similarly, the remaining area on the touch panel 110 (i.e., the area represented by slanted lines) is defined as the inactive area. In other words, in the present embodiment, the managing module 130 can define an active area on the touch panel 110 fitting the user's requirements on the quantity, size, and shape of the active area. It should be noted that, in the above-described embodiments, the determination of the user-configured active area and the touch operation type are simply an exemplary description for convenience, and it does not limit the scope of the invention.

After determining the active area, in a Step S220, the managing module 130 notifies the control chip 120 to disable the inactive area.

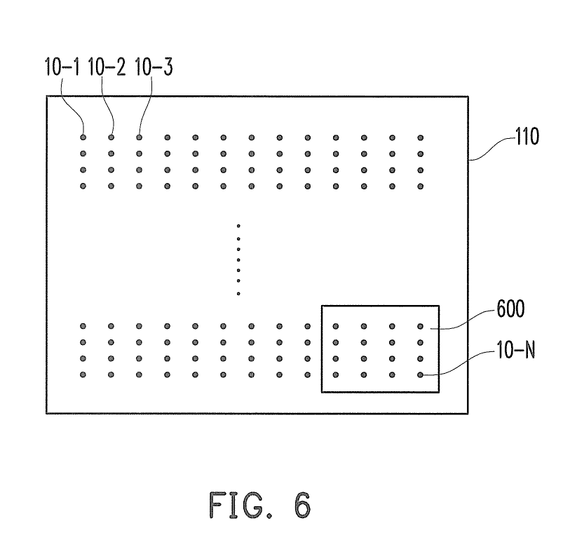

In one embodiment, the control chip 120 disables the inactive area by turning off the power originally provided to the inactive area. For example, as shown in FIG. 6, the touch panel 110 has N touch sensors (e.g., the touch sensors 10-1 to 10-N, in which N is a positive integer). After the managing module 130 determines an active area 600, the control chip 120 only maintains power or provides power to the touch sensors in the active area 600 to enable these touch sensors, and the power of the remaining touch sensors in the inactive area is turned off. In other words, after the power provided to the inactive area is turned off, even when the user touches the inactive area, the touch sensors in the inactive area do not detect the touch from the user.

In another embodiment, the control chip 120 disables the inactive area by turning off a touch function and/or a signal transmission function of the inactive area. Specifically, when the control chip 120 turns off the touch function of the inactive area, even when the user performs a touch operation on the inactive area, the inactive area does not detect any touch signal. When the control chip 120 turns off the signal transmission function of the inactive area, the touch signal detected by the inactive area is not transmitted to the managing module 130.

In another embodiment, when the control chip 120 disables the inactive area, the managing module 130 is notified to not process the touch signals detected in the inactive area. In other words, even when the managing module 130 receives a touch signal detected in the inactive area, the managing module 130 does not process the touch signal.

In a Step S230, the managing module 130 executes a corresponding action on the electronic device according to the touch operation performed on the active area. The action executed on the electronic device may be a pointer movement action, an object selection action, an object drag action, an object open action, or a character input action, and the type of action does not limit the scope of the invention. It should be noted that, the user may self-configure the type of action executed on the electronic device when the touch operation is performed on the active area. For example, in an embodiment of the invention, after selecting the active area, the managing module 130 provides a user interface for the user to configure the touch operation and the corresponding action.

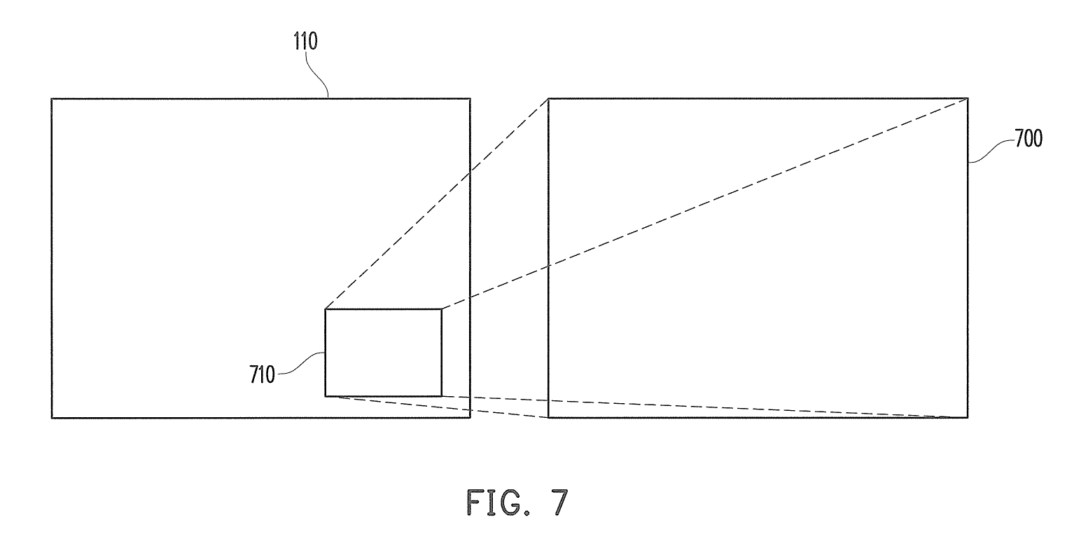

Typically speaking, the touch panel 110 corresponds to the display area of the display of the electronic device. In order for the user to use a portion (e.g., the active area) of the touch panel 110 to control the electronic device, after selecting the active area, the managing module 130 executes a positioning calibration program to redefine a position correlation of the active area and the display area of the display. Taking FIG. 7 as an example, assume that the touch panel 110 corresponds to a display area 700 of a display of the electronic device before the active area is selected. After selecting an active area 710, the managing module 130 executes the positioning calibration program, so the upper-left, lower-left, lower-right, and upper-right points of the active area 710 respectively corresponds to the upper-left, lower-left, lower-right, and upper-right points of the display area 700, and accordingly the position correlation of the active area 710 and the display area 700 is redefined. It should be noted that, the invention does not limit the different types of implementations for the positioning calibration program.

After completing the positioning calibration program, the display area 700 no longer corresponds to the entire touch panel 110, but merely corresponds to the active area 710 in the touch panel 110. Assuming the user configured that the slide movement of fingers or the input apparatus on the active area 710 corresponds to the pointer movement action, then when the user slides fingers or the input apparatus within the active area 710, the managing module 130 correspondingly displays a pointer movement result on the display area 700 according to the redefined position correlation.

In view of the foregoing, according to embodiments of the invention, the control method and system of the touch panel can arbitrarily divide the touch panel into the active area and the inactive area according to the user selection. Moreover, the inactive area is disabled, and only the active area is used to execute an action on the electronic device. Accordingly, the user can self-configure the active area on the touch panel used to operate the electronic device in accordance with habits or requirements, and thereby the convenience and the flexibility of operating the electronic device through the touch panel are enhanced. Since the inactive area has been disabled, therefore power consumption is also lowered and power savings are achieved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A control method of a touch panel, comprising:
selecting at least one active area on the touch panel, and defining the remaining area as an inactive area of the touch panel;
disabling the inactive area; and
executing an action on an electronic device according to a first touch operation performed on the at least one active area.

2. The control method of the touch panel as claimed in claim 1, wherein the step of selecting the at least one active area on the touch panel comprises:
dividing the touch panel into a plurality of predetermined areas; and
determining the at least one active area according to at least one second touch operation performed on at least one of the predetermined areas.

3. The control method of the touch panel as claimed in claim 1, wherein the step of selecting the at least one active area on the touch panel comprises:
determining the at least one active area according to at least one closed area generated by at least one third touch operation performed continuously on the touch panel.

4. The control method of the touch panel as claimed in claim 1, wherein the step of disabling the inactive area comprises:
turning off a power provided to the inactive area.

5. The control method of the touch panel as claimed in claim 4, wherein the touch panel comprises a plurality of touch sensors, and the step of turning off the power provided to the inactive area comprises:
turning off the power provided to the touch sensors disposed in the inactive area.

6. The control method of the touch panel as claimed in claim 1, wherein the step of disabling the inactive area comprises:
turning off at least one of a touch function and a signal transmission function of the inactive area.

7. The control method of the touch panel as claimed in claim 1, wherein the step of disabling the inactive area comprises:
not processing a touch signal detected by or from the inactive area.

8. The control method of the touch panel as claimed in claim 1, wherein the touch panel corresponds to a display area of a display, and after the step of selecting the at least one active area on the touch panel, the method further comprises:
executing a positioning calibration program to redefine a position correlation of the at least one active area and the display area.

9. The control method of the touch panel as claimed in claim 1, wherein the action comprises at least a pointer movement action, an object selection action, an object drag action, an object open action, and a character input action.

10. A control system of a touch panel, comprising:
a touch panel;
a control chip coupled to the touch panel; and
a managing module coupled to the control chip,
wherein the managing module selects at least one active area on the touch panel, and defines the remaining area as an inactive area of the touch panel, the managing module notifies the control chip to disable the inactive area, and the managing module executes an action on an electronic device according to a first touch operation performed on the at least one active area.

11. The control system of the touch panel as claimed in claim 10, wherein the managing module divides the touch panel into a plurality of predetermined areas, and when the touch panel detects at least one second touch operation performed on at least one of the predetermined areas, the control chip transmits at least one area selection command corresponding to the at least one second touch operation to the managing module, and the managing module determines the at least one active area corresponding to the at least one second touch operation.

12. The control system of the touch panel as claimed in claim 10, wherein when the touch panel detects at least one third touch operation performed continuously on the touch panel, the control chip transmits at least one area selection command corresponding to the at least one third touch operation to the managing module, and the managing module determines the at least one active area corresponding to at least one closed area generated by the at least one third touch operation.

13. The control system of the touch panel as claimed in claim 10, wherein the control chip turns off a power provided to the inactive area to disable the inactive area.

14. The control system of the touch panel as claimed in claim 13, wherein the touch panel comprises a plurality of touch sensors, and when the control chip turns off the power provided to the inactive area, the control chip turns off the power provided to the touch sensors disposed in the inactive area.

15. The control system of the touch panel as claimed in claim 10, wherein the control chip turns off at least one of a touch function and a signal transmission function of the inactive area to disable the inactive area.

16. The control system of the touch panel as claimed in claim 10, wherein the control chip notifies the managing module to not process a touch signal detected by or from the inactive area to disable the inactive area.

17. The control system of the touch panel as claimed in claim 10, wherein the touch panel corresponds to a display area of a display, and after the managing module selects the at least one active area, a positioning calibration program is executed to redefine a position correlation of the at least one active area and the display area.

18. The control system of the touch panel as claimed in claim 10, wherein the action comprises at least a pointer movement action, an object selection action, an object drag action, an object open action, and a character input action.
